(19) United States
(12) Patent Application Publication
(10) Pub. No.: US 2024/0220010 A1
(43) Pub. Date: Jul. 4, 2024

(54) TERMINAL APPARATUS AND METHOD OF OPERATING TERMINAL APPARATUS

(71) Applicant: TOYOTA JIDOSHA KABUSHIKI KAISHA, Toyota-shi (JP)

(72) Inventors: Tatsuro HORI, Tokyo-to (JP); Jorge PELAEZ, Kawaguchi-shi (JP)

(73) Assignee: TOYOTA JIDOSHA KABUSHIKI KAISHA, Toyota-shi (JP)

(21) Appl. No.: 18/517,698

(22) Filed: Nov. 22, 2023

(30) Foreign Application Priority Data
Dec. 28, 2022 (JP) 2022-212658

(51) Int. Cl. G06F 3/01; G06F 3/14; G06T 17/00

(52) U.S. Cl. CPC G06F 3/013; G06F 3/1454; G06T 17/00

(57) ABSTRACT

A terminal apparatus includes a communication interface and a controller. The controller is configured to generate a three-dimensional model based on a captured image and distance image of a first user and dispose the generated three-dimensional model in a virtual space. The controller is configured to generate a two-dimensional image of the virtual space based on positional information on one or more eyes of a second user of a separate terminal apparatus and transmit the generated two-dimensional image to the separate terminal apparatus using the communication interface.

### CROSS-REFERENCE TO RELATED APPLICATION

This application claims priority to Japanese Patent Application No. 2022-212658 filed on Dec. 28, 2022, the entire contents of which are incorporated herein by reference.

### TECHNICAL FIELD

The present disclosure relates to a terminal apparatus and a method of operating a terminal apparatus.

### BACKGROUND

Technology for transmitting a two-dimensional image generated from a three-dimensional model is known. For example, Patent Literature (PTL) 1 describes disposing virtual cameras with respect to a three-dimensional model and generating a two-dimensional plane image based on the image acquired by each virtual camera. PTL 1 also describes encoding the generated two-dimensional plane image and transmitting encoded data.

### CITATION LIST

### Patent Literature

PTL 1: JP 2014-096701 A

### SUMMARY

The conventional technology for transmitting a two-dimensional image generated from a three-dimensional model has room for improvement. For example, the conventional technology does not take into account a viewpoint of a user of an apparatus receiving the two-dimensional image.

It would be helpful to provide improved technology for transmitting a two-dimensional image generated from a three-dimensional model.

A terminal apparatus according to an embodiment of the present disclosure includes:
a communication interface; and
a controller configured to:
   generate a three-dimensional model based on a captured image and distance image of a first user;
   dispose the generated three-dimensional model in a virtual space;
   generate a two-dimensional image of the virtual space based on positional information on one or more eyes of a second user of a separate terminal apparatus; and
   transmit the generated two-dimensional image to the separate terminal apparatus using the communication interface.

A method of operating a terminal apparatus according to an embodiment of the present disclosure includes:
generating a three-dimensional model based on a captured image and distance image of a first user;
disposing the generated three-dimensional model in a virtual space;
generating a two-dimensional image of the virtual space based on positional information on one or more eyes of a second user of a separate terminal apparatus; and
transmitting the generated two-dimensional image to the separate terminal apparatus.

According to an embodiment of the present disclosure, improved technology for transmitting a two-dimensional image generated from a three-dimensional model can be provided.

### BRIEF DESCRIPTION OF THE DRAWINGS

In the accompanying drawings:

FIG. 1 is a block diagram of a system according to an embodiment of the present disclosure;

FIG. 2 is a flowchart illustrating an operation procedure of a terminal apparatus illustrated in FIG. 1;

FIG. 3 is a diagram illustrating an example of a virtual space;

FIG. 4 is a diagram illustrating an example of a two-dimensional image; and

FIG. 5 is a flowchart illustrating an operation procedure of the terminal apparatus illustrated in FIG. 1.

### DETAILED DESCRIPTION

An embodiment of the present disclosure will be described below, with reference to the drawings.

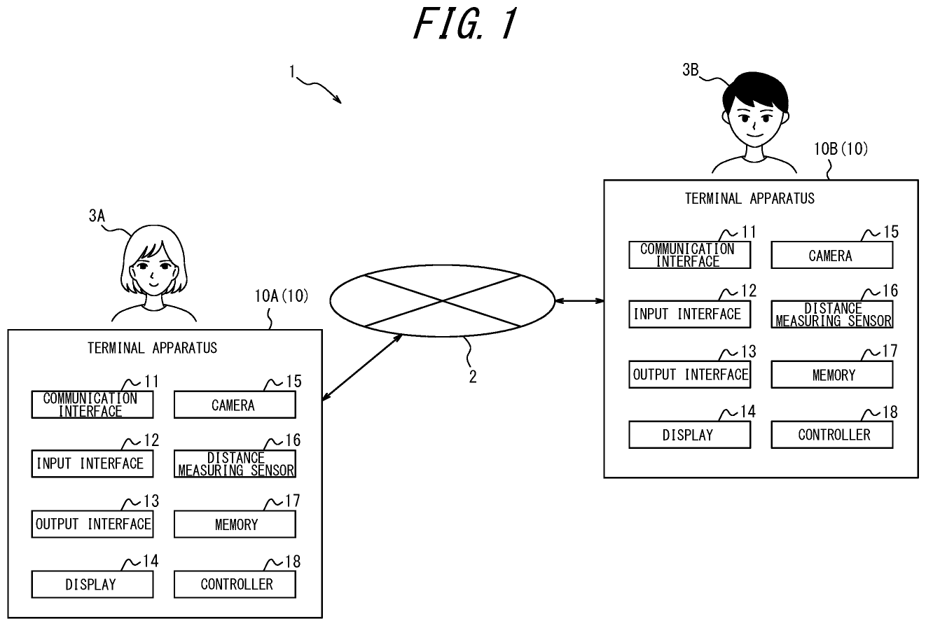

As illustrated in FIG. 1, a system 1 includes a terminal apparatus 10A and a terminal apparatus 10B. Hereinafter, the terminal apparatuses 10A and 10B are also collectively referred to as “terminal apparatus 10” unless particularly distinguished. The system 1 includes two terminal apparatuses 10. However, the system 1 mayinclude two or more terminal apparatuses 10.

The terminal apparatus 10A can communicate with the terminal apparatus 10B via a network 2. The network 2 maybe any network including a mobile communication network, the Internet, or the like. The terminal apparatus 10A and the terminal apparatus 10B may be connected in a Peer to Peer (P2P) architecture.

The system 1 is a system for providing virtual events. The virtual events are provided using virtual space. A virtual event is, for example, a dialogue between participants.

The terminal apparatus 10A is used by a user 3A. The user 3A participates in the virtual event as a participant using the terminal apparatus 10A. The user 3A faces the display 14 of the terminal apparatus 10A. The user 3A interacts with a user 3B in a virtual event.

The terminal apparatus 10B is used by a user 3B. The user 3B participates in the virtual event as a participant using the terminal apparatus 10B. The user 3B faces the display 4 of the terminal apparatus 10B. The user 3B interacts with the user 3A in a virtual event.

Each of the terminal apparatuses 10 is, for example, a terminal apparatus such as a desktop personal computer (PC), a tablet PC, a notebook PC, or a smartphone.

### Configuration of Terminal Apparatus

As illustrated in FIG. 1, the terminal apparatus 10 includes a communication interface 11, an input interface 12, an output interface 13, a display 14, a camera 15, a distance measuring sensor 16, a memory 17, and a controller 18.

The communication interface 11 is configured to include at least one communication module for connection to the network 2. For example, the communication module is, for example, a communication module compliant with a standard such as a wired local area network (LAN) standard or a wireless LAN standard, or a mobile communication standard such as the Long Term Evolution (LTE) standard, the 4th Generation (4G) standard, or the 5th Generation (5G) standard.

The input interface 12 is capable of accepting an input from a user. The input interface 12 is configured to include at least one interface for input that is capable of accepting an input from a user. The interface for input is, for example, a physical key, a capacitive key, a pointing device, a touch screen integrally provided with a display of the display 14, a microphone, or the like.

The output interface 13 can output data. The output interface 13 is configured to include at least one interface for output that is capable of outputting the data. The interface for output is a speaker or the like.

The display 14 is capable of displaying data. The display 14 comprises, for example, a display, etc. The display is, for example, a liquid crystal display (LCD), an organic electro-luminescent (EL) display, or the like.

The camera 15 is capable of imaging subjects to generate captured images. The camera 15 is, for example, a visible light camera. The camera 15 continuously images subjects at any frame rate, for example. The captured image is a color image (RGB image). However, the captured image may be a monochrome image.

The distance measuring sensor 16 can generate a distance image of a subject by measuring the distance from the display 14 display to the subject. The distance image is an image in which a pixel value of each pixel corresponds to a distance. The distance measuring sensor 16 includes, for example, a Time of Flight (ToF) camera, a Light Detection And Ranging (LiDAR), a stereo camera, or the like.

The memory 17 is configured to include at least one semiconductor memory, at least one magnetic memory, at least one optical memory, or a combination of at least two of these. The memory 17 mayfunction as a main memory, an auxiliary memory, or a cache memory. The memory 17 stores data to be used for operations of the terminal apparatus 10 and data obtained by the operations of the terminal apparatus 10.

The controller 18 is configured to include at least one processor, at least one dedicated circuit, or a combination thereof. The processor is, for example, a general purpose processor such as a Central Processing Unit (CPU) or a Graphics Processing Unit (GPU), or a dedicated processor that is dedicated to a specific process. The controller 18 executes processes related to the operations of the terminal apparatus 10 while controlling the components of the terminal apparatus 10.

### Operations of Terminal Apparatus

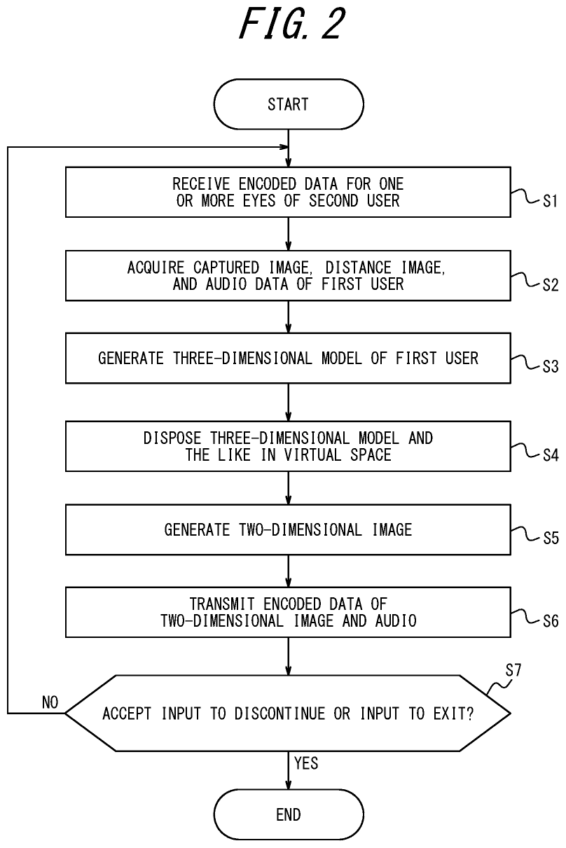

FIG. 2 is a flowchart illustrating an operation procedure of the terminal apparatuses 10 illustrated in FIG. 1. The operation procedure illustrated in FIG. 2 is common to the terminal apparatuses 10A and 10B. The operation procedure illustrated in FIG. 2 is an example of an operating method of the terminal apparatuses 10 according to the present embodiment. In the following description, it is assumed that the terminal apparatus 10A performs the operation procedure illustrated in FIG. 2. The controller 18 starts processing step S1 when the encoded data for one or more eyes of the user 3B is sent from the terminal apparatus 10B to the terminal apparatus 10A in a virtual event.

In the processing of step S1, the controller 18 controls the communication interface 11 to receive the encoded data for one or more eyes of the user 3B from the terminal apparatus 10B via the network 2. The controller 18 acquires information about the eye of the user 3B by decoding the received encoded data. The eye information of the user 3B includes positional information on one or more eyes of the user 3B, information on a direction of a line of sight of the user 3B′ and on a field of view of the user 3B. The positional information on the one or more eyes of the user 3B is given, for example, as coordinates in a coordinate system set with respect to the display 14 of the terminal apparatus 10B.

In the processing of step S2, the controller 18 acquires data on captured images of the user 3A, by controlling the camera 15 to capture the user 3A as a subject. The controller 18 acquires the data of the distance image of the user 3A by having the distance measuring sensor 16 generate the distance image of the user 3A with the user 3A as the subject. The controller 18 also acquires audio data of the user 3A by collecting the voice of the user 3A using a microphone of the input interface 12.

In the processing of step S3, the controller 18 generates a three-dimensional model 4A of the user 3A using data of the captured image and the distance image of the user 3A acquired in the processing of step S2. For example, the controller 18 generates a polygon model using the data of the distance image of the user 3A. Furthermore, the controller 18 generates the three-dimensional model 4A of the user 3A by applying texture mapping to the polygon model using the data of the captured image of the user 3A.

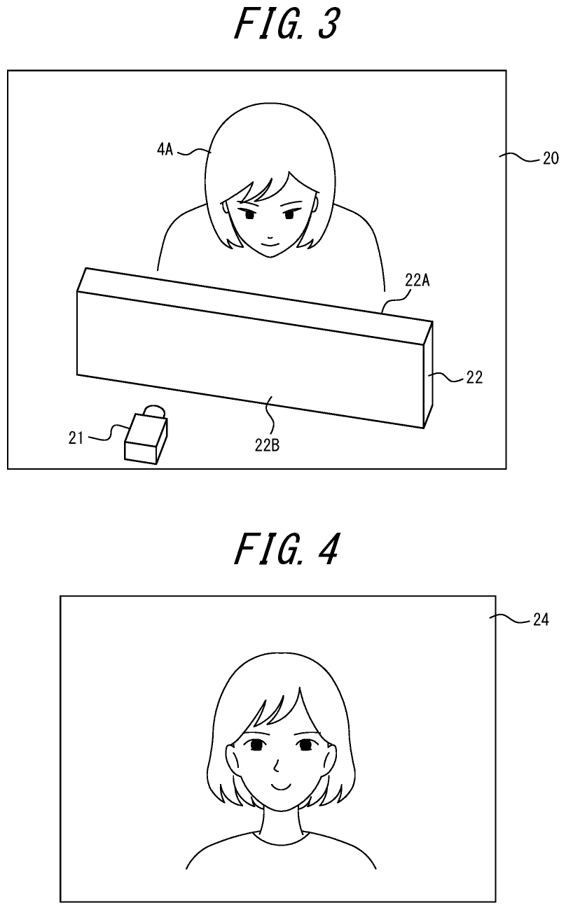

In the processing of step S4, the controller 18 disposes the three-dimensional model 4A generated in the processing of step S3 and a virtual camera 21 in a virtual space 20, as illustrated in FIG. 3. The controller 18 disposes a virtual screen 22 between the three-dimensional model 4A and the virtual camera 21. The virtual screen 22 includes a surface 22A on the side of the three-dimensional model 4A and a surface 22B on the side of the virtual camera 21. The surface 22A corresponds to a display screen of the display 14 of the terminal apparatus 10A. The surface 22B corresponds to a display screen of the display 14 of the terminal apparatus 10B.

In the processing of step S4, the controller 18 disposes the virtual camera 21 based on positional information on the one or more eyes of the user 3B acquired in the processing of step S1. For example, the controller 18 positions the virtual camera 21 so that the position of the virtual camera 21 relative to the surface 22B is the same as the position of the eyes of user 3B relative to the display screen of the display 14 of the terminal apparatus 10B. Furthermore, the controller 18 mayposition the virtual camera 21 so that each of the orientation and field of view of the virtual camera 21 relative to the plane 22B is the same as each of the orientation and field of view of the eyes of the user 3B.

In the processing of step S5, the controller 18 generates, by rendering, a two-dimensional image 24 of the virtual space 20 projected on the virtual screen 22 as seen from the virtual camera 21, as illustrated in FIG. 3. The controller 18 produces a two-dimensional image 24 as shown in FIG. 4. The two-dimensional image 24 depicts a three-dimensional model 4A as seen from the virtual camera 21, as shown in FIG. 3. The two-dimensional image 24 generated is a color image (RGB image). However, the two-dimensional image 24 maybe a monochrome image.

In the processing of step S6, the controller 18 encodes the two-dimensional image 24 generated in the processing of step S5 and the audio data acquired in the processing of step S2, thereby generating encoded data of the two-dimensional image 24 and audio. In encoding, the controller 18 mayperform any processing (for example, resolution change, cropping, or the like) on the data on the two-dimensional image 24 or the like. The controller 18 controls the communication interface 11 to transmit the encoded data of the generated two-dimensional image 24 and audio to the terminal apparatus 10B via the network 2.

In the processing of step S7, the controller 18 determines whether the input interface 12 has accepted an input to discontinue imaging and the like or an input to exit from the virtual event. When it is determined that the input to discontinue imaging and the like or the input to exit from the virtual event has been accepted (step S7: YES), the controller 18 ends the operation procedure as illustrated in FIG. 2. When it is not determined that the input to discontinue imaging and the like or the input to exit from the virtual event has been accepted (step S7: NO), the controller 18 returns to the processing of step S1.

Here, the positional information on the one or more eyes of the user 3B acquired in the process of step S1 may include both the positional information of the left eye and the right eye of the user 3B. In this case, in processing step S4, the controller 18 mayposition the virtual camera 21 based on either the left eye positional information or the right eye positional information of user 3B, or it may position the virtual camera 21 based on the position information of both the left and right eyes of the user 3B. When using the positional information on both the left and right eye of the user 3B, the controller 18 mayacquire the positional information between the left and right eye of the user 3B by the positional information on the left and right eye of the user 3B. The controller 18 mayposition the virtual camera 21 so that the position of the virtual camera 21 relative to the surface 22B is the same as the position between the left and right eyes of the user 3B relative to the display screen of the display 14 of terminal apparatus 10B.

In the process of steps S1 to S7 to be performed repeatedly, the controller 18 does not have to perform the process of step S1 if the encoded data for one or more eyes of the user 3B is not sent from terminal apparatus 10B to terminal apparatus 10A. In this case, in the process of step S4, the controller 18 mayposition the virtual camera 21 based on the already acquired eye information of the user 3B.

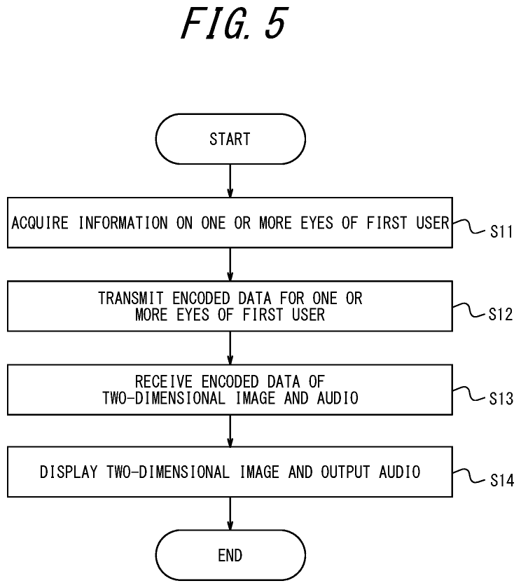

FIG. 5 is a flowchart illustrating an operation procedure of the terminal apparatuses 10 illustrated in FIG. 1. The operation procedure illustrated in FIG. 5 is common to the terminal apparatuses 10A and 10B. The operation procedure illustrated in FIG. 5 is an example of an operating method of the terminal apparatuses 10 according to the present embodiment. In the following description, it is assumed that the terminal apparatus 10B performs the operation procedure illustrated in FIG. 5.

In the processing of step S11, the controller 18 acquires information on one or more eyes of the user 3B. For example, the controller 18 acquires the data of the captured image of the user 3B's eye by having the camera 15 capture the eye of the user 3B as a subject. The controller 18 acquires positional information on one or more eyes of the user 3B, information on a direction of a line of sight of the user 3B and on a field of view of the user 3B as information on user 3B's eyes by analyzing the data of the captured image of user 3B's eyes. For the eye positional information of the user 3B, the controller 18 acquires the positional information of one of the left eye and the right eye of the user 3B. However, controller 18 mayacquire positional information for both the left and right eye of the user 3B. Alternatively, controller 18 mayacquire the position between the left eye and the right eye of the user 3B as the positional information on one or more eyes of the user 3. Here, controller 18 mayacquire the distance image data of user 3B by causing the distance measuring sensor 16 to generate a distance image of user 3B's face with the user 3B as the subject. The controller 18 mayacquire positional information on one or more eyes of the user 3B, information on the direction of a line of sight of the user 3B and on a field of view of the user 3B by analyzing the data of the distance image of user 3B instead of or in addition to the captured image of the user 3B's eyes.

In the processing of step S12, the controller 18 generates encoded data of one or more eyes of the user 3B by encoding the information on the one or more eyes of the user 3B acquired in the processing of step S11. The controller 18 controls the communication interface 11 to transmit the generated encoded data on the one or more eyes of the user 3B to the terminal apparatus 10A via the network 2.

In the processing of step S13, the controller 18 controls the communication interface 11 to receive the encoded data of the two-dimensional image 24 as illustrated in FIG. 4 and the audio from the terminal apparatus 10A via the network 2. The controller 18 acquires the two-dimensional image 24 and audio data by decoding the received encoded data.

In the processing of step S14, the controller 18 controls the display 14 to display the two-dimensional image 24 acquired in the processing of step S13. The controller 18 controls a speaker of the output interface 13 to output the audio data acquired in the processing of step S13. This configuration allows the user 3B to converse with the user 3A while viewing the two-dimensional image 24 displayed on the display 14.

Thus, the terminal apparatus 10A according to the present embodiment, controller 18 generates a three-dimensional model 4A based on the captured image and distance image of the user 3A, and places the generated the three-dimensional model 4A in the virtual space 20. The controller 18 generates a two-dimensional image 24 of the virtual space 20 based on positional information on one or more eyes of a second user of a separate terminal apparatus 10, i.e., the user 3B of the terminal apparatus 10B in the present embodiment. By generating a two-dimensional image 24 of the virtual space 20 based on the positional information on one or more eyes of the user 3B, the two-dimensional image 24 has the distance to user 3A as seen from user 3B when user 3B is facing user 3A. With this configuration, when the two-dimensional image 24 is displayed on the display 14 of the terminal apparatus 10B, user 3B can feel as if he/she is facing user 3A through a mirror.

As a comparative example, consider the case where the terminal apparatus 10B generates data for a two-dimensional image 24. In this case, the terminal apparatus 10A is required to send the data of the captured image and distance image of user 3A to the terminal apparatus 10B. The terminal apparatus 10A is required to synchronize the captured image of user 3A with the distance image and transmit it to the terminal apparatus 10B.

In contrast to this comparison, in terminal apparatus 10A for the present embodiment, controller 18 generates a two-dimensional image 24 and transmits the data of the generated two-dimensional image 24 to another terminal apparatus 10, namely terminal apparatus 10B in this embodiment. With this configuration, the present embodiment does not need to send the data of the captured image and distance image of the user 3A from the terminal apparatus 10A to the terminal apparatus 10B as in the comparative example. Therefore, the amount of data communication between terminal apparatus 10A and terminal apparatus 10B can be reduced in the present embodiment than in the case of transmitting the data of the captured image and distance image of user 3A from terminal apparatus 10A to terminal apparatus 10B as in the comparative example. In addition, the present embodiment eliminates the need for the terminal apparatus 10A to synchronize the captured image of the user 3A with the distance image and transmit it to the terminal apparatus 10B, as in the comparative example. This configuration simplifies the terminal apparatuses 10 transmission process.

Therefore, according to the present embodiment, improved technology for transmitting a two-dimensional image generated from a three-dimensional model can be provided.

Furthermore, in the terminal apparatus 10A according to the present embodiment, when controller 18 receives new positional information on the eye of user 3B from the terminal apparatus 10B by the communication interface 11, it may generate a new two-dimensional image based on the received new position information of the eye of user 3B. With this configuration, a two-dimensional image can be generated and sent to terminal apparatus 10B according to the movement of user 3B's viewpoint.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in the embodiment described above, the terminal apparatus 10A and the terminal apparatus 10B are described as performing the virtual event by communicating directly with each other via the network 2. However, the terminal apparatus 10A and the terminal apparatus 10B may perform the virtual event by communicating via a server apparatus.

For example, in the embodiment described above, the terminal apparatus 10A and the terminal apparatus 10B are described as transmitting and receiving the encoded data of the two-dimensional image and audio. The terminal apparatus 10A and the terminal apparatus 10B are described as transmitting and receiving the encoded data for one or more eyes of a user. However, depending on the communication method between the terminal apparatus 10A and the terminal apparatus 10B, the two-dimensional image and audio data may be sent and received instead of the encoded data of the two-dimensional image and audio. Depending on the communication method between the terminal apparatus 10A and the terminal apparatus 10B, the information on one or more eyes of the user may be sent and received instead of the encoded data of the eyes of the user.

For example, an embodiment in which a general purpose computer functions as the terminal apparatuses 10 according to the above embodiment can also be implemented. Specifically, a program in which processes for realizing the functions of the terminal apparatuses 10 according to the above embodiment are written may be stored in a memory of a general purpose computer, and the program may be read and executed by a processor.

Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1] A terminal apparatus comprising:
a communication interface; and
a controller configured to:
   generate a three-dimensional model based on a captured image and distance image of a first user;
   dispose the generated three-dimensional model in a virtual space;
   generate a two-dimensional image of the virtual space based on positional information on one or more eyes of a second user of a separate terminal apparatus; and
   transmit the generated two-dimensional image to the separate terminal apparatus using the communication interface.
      [Appendix 2] The terminal apparatus according to appendix 1, wherein the controller is configured to receive the positional information on the one or more eyes of the second user, using the communication interface, from the separate terminal apparatus.
      [Appendix 3] The terminal apparatus according to appendix 1 or 2, wherein the controller is configured to, upon receiving new positional information on the one or more eyes of the second user, using the communication interface, from the separate terminal apparatus, newly generate the two-dimensional image based on the received new positional information on the one or more eyes of the second user.
      [Appendix 4] The terminal apparatus according to any one of appendices 1 to 3, wherein the controller is configured to generate the two-dimensional image of the virtual space based further on information on a direction of a line of sight of the second user and on a field of view of the second user.
      [Appendix 5] A method of operating a terminal apparatus, the method comprising:
generating a three-dimensional model based on a captured image and distance image of a first user;
disposing the generated three-dimensional model in a virtual space;
generating a two-dimensional image of the virtual space based on positional information on one or more eyes of a second user of a separate terminal apparatus; and
transmitting the generated two-dimensional image to the separate terminal apparatus.
   [Appendix 6] A program configured to cause a computer to execute operations, the operations comprising:
generating a three-dimensional model based on a captured image and distance image of a first user;
disposing the generated three-dimensional model in a virtual space;
generating a two-dimensional image of the virtual space based on positional information on one or more eyes of a second user of a separate terminal apparatus; and
transmitting the generated two-dimensional image to the separate terminal apparatus.

1. A terminal apparatus comprising:
a communication interface; and
a controller configured to:
generate a three-dimensional model based on a captured image and distance image of a first user;
dispose the generated three-dimensional model in a virtual space;
generate a two-dimensional image of the virtual space based on positional information on one or more eyes of a second user of a separate terminal apparatus; and
transmit the generated two-dimensional image to the separate terminal apparatus using the communication interface.

2. The terminal apparatus according to claim 1, wherein the controller is configured to receive the positional information on the one or more eyes of the second user, using the communication interface, from the separate terminal apparatus.

3. The terminal apparatus according to claim 2, wherein the controller is configured to, upon receiving new positional information on the one or more eyes of the second user, using the communication interface, from the separate terminal apparatus, newly generate the two-dimensional image based on the received new positional information on the one or more eyes of the second user.

4. The terminal apparatus according to claim 1, wherein the controller is configured to generate the two-dimensional image of the virtual space based further on information on a direction of a line of sight of the second user and on a field of view of the second user.

5. A method of operating a terminal apparatus, the method comprising:
generating a three-dimensional model based on a captured image and distance image of a first user;
disposing the generated three-dimensional model in a virtual space;
generating a two-dimensional image of the virtual space based on positional information on one or more eyes of a second user of a separate terminal apparatus; and
transmitting the generated two-dimensional image to the separate terminal apparatus.
